(19) United States
(12) Patent Application Publication
(10) Pub. No.: US 2009/0070708 A1
(43) Pub. Date: Mar. 12, 2009

(54) Display of Information of Interest

(75) Inventor: Jeffrey Finkelstein, San Francisco, CA (US)

Correspondence Address: FENWICK & WEST LLP, SILICON VALLEY CENTER, 801 CALIFORNIA STREET, MOUNTAIN VIEW, CA, 94041, US

(73) Assignee: PALM, INC., Sunnyvale, CA (US)

(21) Appl. No.: 11/854,374

(22) Filed: Sep. 12, 2007

(51) Int. Cl. G06F 3/048

(52) U.S. Cl. 715/789

(57) ABSTRACT

A system (and a method) is disclosed to render information of interest on a computing device. The system is configured to identify a plurality of time periods within in a database and to access a user profile. The user profile includes data on information of interest for a user. The system compares, for each time period, the user profile with that specific time period to determine the information of interest for the user within the specific time period. The system retrieves, in response to the comparison, information from at least one data source corresponding to the determined information of interest for the user within the specific time period. The system renders at a time relative to each time period a home screen on a display of the computing device, the home screen including the determined information of interest for the user within the specific time period.

### BACKGROUND

1. Field of Art

The disclosure generally relates to the field of contextual information displayable on a computing device.

2. Description of the Related Art

Conventional operating systems on a conventional computing system typically render a desktop screen or today screen at the start of operation. For example, an Intel processor based computing system such as a laptop or desktop computer, a Microsoft Windows operating system renders the desktop screen where elements such as the task bar and toolbar are located. On handheld computing devices, the Microsoft Windows Mobile renders a Today Screen and the Research in Motion Blackberry operating system renders a screen similar to a desktop screen, i.e., a screen with a multitude of selectable icons corresponding to applications.

In each instance, the operating system base screen (e.g., the desktop screen or the today screen), the displayed information remains relatively static. For example, on the conventional desktop screen, other than a change in date or time the remainder of the information remains the same unless manually changed by the user. In the case of the today screen, the information does change on a daily basis to reflect the contents of a calendar application also present on the handheld device. Hence, the information presented remains substantially static regardless of how the user interacts with the computing device throughout the day.

One problem with conventional systems is that they result in substantial time waste. In order to get any dynamic information corresponding to any part of the user day, the user must manually and actively go out and seek that information and have that information thereafter rendered on the screen. The process to actively seek and retrieve appropriate data at appropriate times throughout the day results in decreased user productivity and increased time resources.

Another problem with more recent conventional computing systems is limited screen real estate (or size). For example, handheld devices often have a screen size approximately 4 to 7 centimeters by 4 to 8 centimeters. This small size limits the amount of information presentable on the screen before the information becomes too small to read or must be altogether omitted except for the most basic information, e.g., a few icons and perhaps date and time. The user is once more presented with the dilemma of having to actively go out to search and retrieve relevant information to display onto the screen. Thus, the user loses productivity as time must be consumed to collect appropriate information.

Thus, the present state of the art lacks, inter alia, mechanisms and processes to analyze information that may be relevant for a user of a computing device, gathering that information and rendering it on a base screen (e.g., the desktop screen or today screen).

### SUMMARY

One embodiment of a disclosed system (and method) renders information of specific interest at particular times on a display of a computing device. The system is configured to identify a plurality of data entries, for example, time periods within in a database, and to access a user profile. The user profile includes data on information of interest for a user. The system compares, for each time period, the user profile with that specific time period to determine the information of interest for the user within the specific time period. The system retrieves, in response to the comparison, information from at least one data source corresponding to the determined information of interest for the user within the specific time period. The system renders at a time relative to each time period a home (or base) screen on a display of the computing device, the home screen including the determined information of interest for the user within the specific time period.

In one embodiment, it is noted that the screen of a device may be in an OFF (or off) state when the device is not in use. However, processing within the device may continue in such instances so that the displayed base screen having new information is presented to the user when the screen is powered to an ON (or on) state.

By way of example, reference is made to an embodiment in which a mobile computing device, e.g., a smartphone or handheld computing device, has a small-form factor screen (e.g., approximately 5 centimeters by 5 centimeters). The system is configured so that when viewing web content on such device the user is limited by the size of the screen, specifically, preventing the user from quickly accessing all the web information for view in a single glance. By accessing system level location based data from a source external to the device, e.g., from a web service, and a source internal to the device, e.g., a calendar application storing events data, the user improves the relevancy and usability of personalized web content by prioritizing the display of information most important to the user at a given time and location without searching and launching web bookmarks.

In another example, the system is configured so that the user may wake up in the morning glance down at the present day view on the screen, e.g., at the triggering of an alarm clock function in the device that places the screen in an ON state or by the user activating the screen to the ON state upon waking up. This initial base screen may be configured to display present traffic data and weather updates in preparation for a commute to work. Thereafter, the user may not use the device for some time period and the screen may be in an OFF state. Later that afternoon at lunch break the user may trigger the screen to an ON state and may glance down to a new based screen and see a link to a funny viral video and industry news, but no longer see the traffic and weather details as they may no longer be relevant. Once again the screen may thereafter move to an OFF state if the user does not use the device for another time period. Later that day as the user prepares to head home from the office; the user places the screen in an ON state and looks at the base screen where the user is presented with traffic updates for the commute home as well as headline news from current nightly news reports.

In yet another example, the system is configured to adjust to the events of that particular time and day. For example, if the user typically commutes from San Francisco, Calif. to Sunnyvale, Calif., but today has a meeting with XYZ Company in Berkeley, Calif., the traffic and weather details to Sunnyvale are irrelevant. Hence, the system is configured so that when the user powers on my device the present day view displays a traffic report and weather conditions from San Francisco to Berkeley rather than Sunnyvale. Moreover, at a predetermined time prior to beginning the meeting (e.g., 15 minutes prior to the meeting) at the company in Berkeley, the system is configured to provide particular details on XYZ Company that may be relevant for the meeting, for example, the present day view screen would display headlines about the company and relevant industry news about their product line and competitors.

In still another example embodiment, the system is configured to also account for the particular day of the week. For example, on a Saturday the user would wake up and may have no items on the present day view, but could be presented with local events information and movie times for the user location, which may correspond to preconfigured personalization settings set by the user. In this view, no traffic details may be provided at the time because they likely are not relevant for the user at that time.

The disclosed embodiments dynamically retrieves and renders on a display a base (or home) screen (or view) that is of particular interest within a particular time period identified on the device. It is noted that base screen is a main workspace in a graphical user interface of an operating system. Users can open and work with files and programs (or applications) on the desktop, and can store files and shortcuts there as well. The user can also customize the look of the desktop with image themes or wallpaper. It its noted that the base screen differs from an applications launcher in that the base screen contains, for example, shortcuts to frequently used applications whereas the application launcher (or programs view) is used to directly launch applications or programs. The base screen in accordance with the aspects disclosed herein simplifies tasks for user by consistently presenting the most pertinent information to the user on the home screen of the device. The user need not expend extra cycles and efforts to retrieve the information from a variety of sources.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

The disclosed embodiments have other advantages and features which will be more readily apparent from the detailed description, the appended claims, and the accompanying drawings, in which:

FIG. (or FIG.) 1 illustrates one embodiment of a mobile computing device.

FIG. 2 illustrates one embodiment of an architecture of a mobile computing device.

FIG. 3 illustrates one embodiment of a process to display specific information of interest within a specific time period.

FIGS. 4a through 4f illustrate example home (or base) screens for one embodiment of process to display specific information of interest within a specific time period.

### DETAILED DESCRIPTION

The Figures (or FIGS.) and the following description relate to preferred embodiments by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Mobile Computing Device

FIG. 1 illustrates one embodiment of a mobile computing device 110 with telephonic functionality, e.g., a mobile phone or a smartphone. The mobile computing device is configured to host and execute a phone application for placing and receiving telephone calls. It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with public switched telephone networks (PSTN) or data networks having voice over internet protocol (VoIP) functionality.

The mobile computing device 110 is configured to be of a form factor that is convenient to hold in a user's hand, for example, a personal digital assistant (PDA) or a smart phone form factor. For example, the mobile computing device 110 can have dimensions ranging from 7.5 to 15.5 centimeters in length, 5 to 12.75 centimeters in width, 0.64 to 2.2 centimeters in height and weigh between 55 and 230 grams.

The mobile computing device 110 includes a speaker 120, a screen 130, a navigation area 140, a keypad area 150, and a microphone 160. The mobile computing device 110 also may include one or more switches 170, 170a, 170b (generally 170). The one or more switches 170 may be buttons, sliders, or rocker switches and can be mechanical or solid state (e.g., touch sensitive solid state switch).

The screen 130 of the mobile computing device 110 is, for example, a 240×240, a 320×320, or a 320×480 transflective display. For example, the screen 130 comprises an active matrix liquid crystal display (AMLCD), a thin-film transistor liquid crystal display (TFT-LCD), an organic light emitting diode (OLED), an interferometric modulator display (IMOD), a liquid crystal display (LCD), or other suitable display device. In an embodiment, the display displays color images. In another embodiment, the screen 120 further comprises a touch-sensitive display (e.g., pressure-sensitive (resistive), electrically sensitive (capacitative), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The navigation area 140 is configured to control functions of an application executing in the mobile computing device 110 and visible through the screen 130. For example, the navigation area includes an x-way (x is e.g., 5) navigation ring 145 that provides cursor control, selection, and similar functionality. In addition, the navigation area 140 may include selection buttons 143a, 143b to select functions viewed just above the buttons on the screen 130. In addition, the navigation area 140 also may include dedicated function buttons 147 for functions such as, for example, a calendar, a web browser, an e-mail client or a home screen. In this example, the navigation ring 145 may be implemented through mechanical, solid state switches, dials, or a combination thereof. The keypad area 150 may be a numeric keypad (e.g., a dialpad) or a numeric keypad integrated with an alpha or alphanumeric keypad 160 (e.g., a keyboard with consecutive keys of QWERTY, AZERTY, or other equivalent set of keys on a keyboard).

Although not illustrated, it is noted that the mobile computing device 110 also may include an expansion slot 125. The expansion slot 125 is configured to receive and support expansion cards (or media cards), which may include memory cards such as CompactFlash™ cards, SD cards, XD cards, Memory Sticks™, MultiMediaCard™, SDIO, and the like.

### Example Mobile Computing Device Architectural Overview

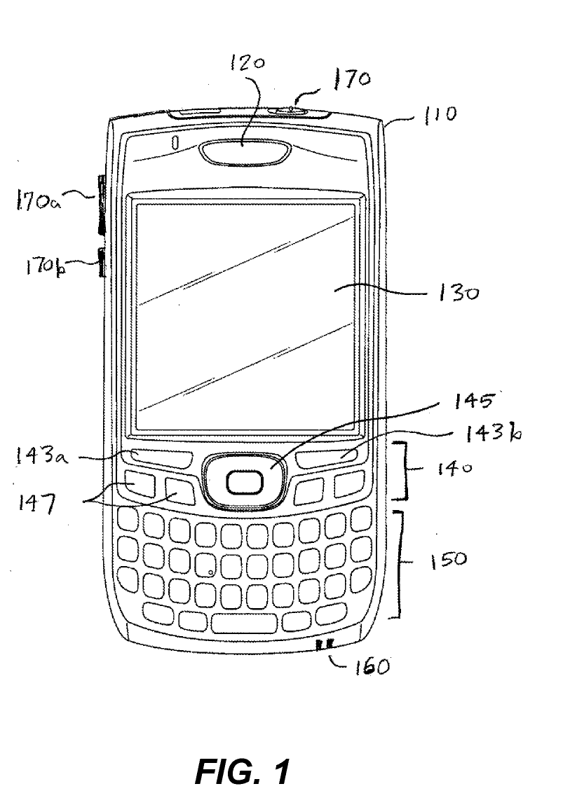

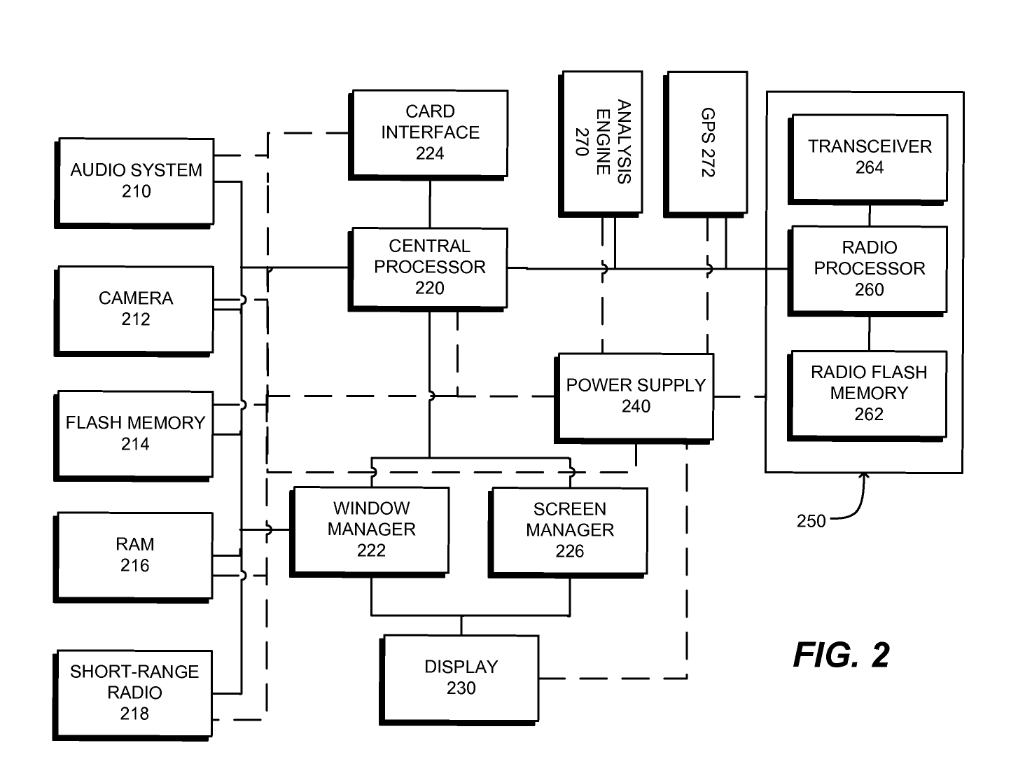

Referring next to FIG. 2, a block diagram illustrates one embodiment of an architecture of a mobile computing device 110, with telephonic functionality. By way of example, the architecture illustrated in FIG. 2 will be described with respect to the mobile computing device of FIG. 1. The mobile computing device 110 includes a central processor 220, a power supply 240, and a radio subsystem 250. The central processor 220 communicates with: audio system 210, camera 212, flash memory 214, RAM memory 216, short range radio module 218 (e.g., Bluetooth, Wireless Fidelity (WiFi) component), a window manager 222, a screen manager 226, and an analysis engine 270. The power supply 240 powers the central processor 220, the radio subsystem 250 and a display driver 230 (which may be contact- or inductive-sensitive). The power supply 240 may correspond to a battery pack (e.g., rechargeable) or a powerline connection or component.

In one embodiment, the window manager 222 comprises a software or firmware process that initializes a virtual display space stored in the RAM 216 and/or the flash memory 214. The virtual display space includes one or more applications currently being executed by a user and the current status of the executed applications. The window manager 222 receives requests, from user input or from software or firmware processes, to show a window and determines the initial position of the requested window. Additionally, the window manager 222 receives commands or instructions to modify a window, such as resizing the window, moving the window or any other command altering the appearance or position of the window, and modifies the window accordingly.

The screen manager 226 comprises a software or firmware process that manages content displayed on the screen 130. In one embodiment, the screen manager 226 monitors and controls the physical location of data displayed on the screen 130 and which data is displayed on the screen 130. The screen manager 260 alters or updates the location of data on the screen 130 responsive to input from the central processor 220, to modify the screen 130 appearance. In one embodiment, the screen manager 226 also monitors and controls screen brightness and transmits control signals to the central processor 220 to modify screen brightness and power usage to the screen 130.

The radio subsystem 250 includes a radio processor 260, a radio memory 262, and a transceiver 264. The transceiver 264 may be two separate components for transmitting and receiving signals or a single component for both transmitting and receiving signals. In either instance, it is referenced as a transceiver 264. The receiver portion of the transceiver 264 communicatively couples with a radio signal input of the device 110, e.g., an antenna, where communication signals are received from an established call (e.g., a connected or on-going call). The received communication signals include voice (or other sound signals) received from the call and processed by the radio processor 260 for output through the speaker 120 (or 184). The transmitter portion of the transceiver 264 communicatively couples a radio signal output of the device 110, e.g., the antenna, where communication signals are transmitted to an established (e.g., a connected (or coupled) or active) call. The communication signals for transmission include voice, e.g., received through the microphone 160 of the device 110, (or other sound signals) that is processed by the radio processor 260 for transmission through the transmitter of the transceiver 264 to the established call.

In one embodiment, communications using the described radio communications may be over a voice or data network. Examples of voice networks include Global System of Mobile (GSM) communication system, a Code Division, multiple Access (CDMA system), and a Universal Mobile Telecommunications System (UMTS). Examples of data networks include General Packet Radio Service (GPRS), third-generation (3G) mobile, High Speed Download Packet Access (HSDPA), and Worldwide Interoperability for Microwave Access (WiMAX).

While other components may be provided with the radio subsystem 250, the basic components shown provide the ability for the mobile computing device to perform radio-frequency communications, including telephonic communications. In an embodiment, many, if not all, of the components under the control of the central processor 220 are not required by the radio subsystem 250 when a telephone call is established, e.g., connected or ongoing. The radio processor 260 may communicate with central processor 220 using a serial line 278. It is noted that the system may also include a global positioning system (GPS) subsystem 272 that is configured to communicatively couple with a GPS communication system. The GPS subsystem 272 allows for obtaining specific location information relative to the location of the device 110.

The analysis engine 270 is configured to analyze data from various sources within the device 110, for example, personal information manager components and databases such as a calendar and/or a contacts database. In addition, it can access and integrate into a particular analysis information from other sources internal to the device 110 (e.g., the global positioning system subsystem (GPS) 272) and/or external to the device 110 (e.g., web services). Additional operational details and processes of the analysis engine are further described below.

The card interface 224 is adapted to communicate with the expansion slot expansion slot 125. The card interface 224 transmits data and/or instructions between the central processor and an expansion card or media card included in the expansion slot 125. The card interface 224 also transmits control signals from the central processor 220 to the expansion slot 125 to configure an expansion card or media card included in the expansion slot 125.

In one embodiment, central processor 220 executes logic (by way of programming, code, instructions) corresponding to executing applications interfaced through, for example, the navigation area 140 or switches 170. It is noted that numerous other components and variations are possible to the hardware architecture of the computing device 200, thus an embodiment such as shown by FIG. 2 is just illustrative of one implementation for an embodiment.

### Displaying Specific Information of Interest in a Specific Time Period

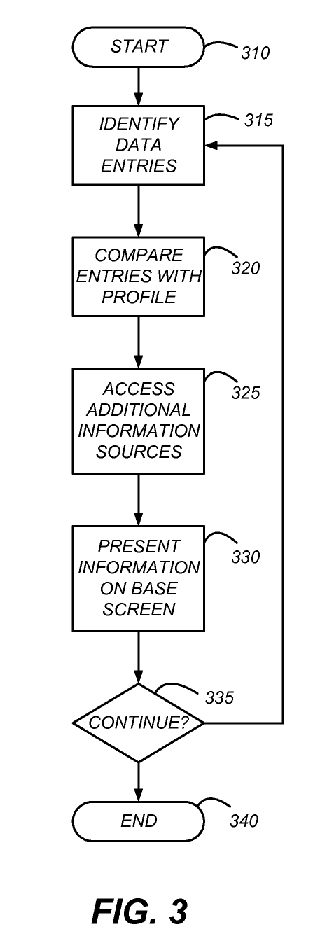

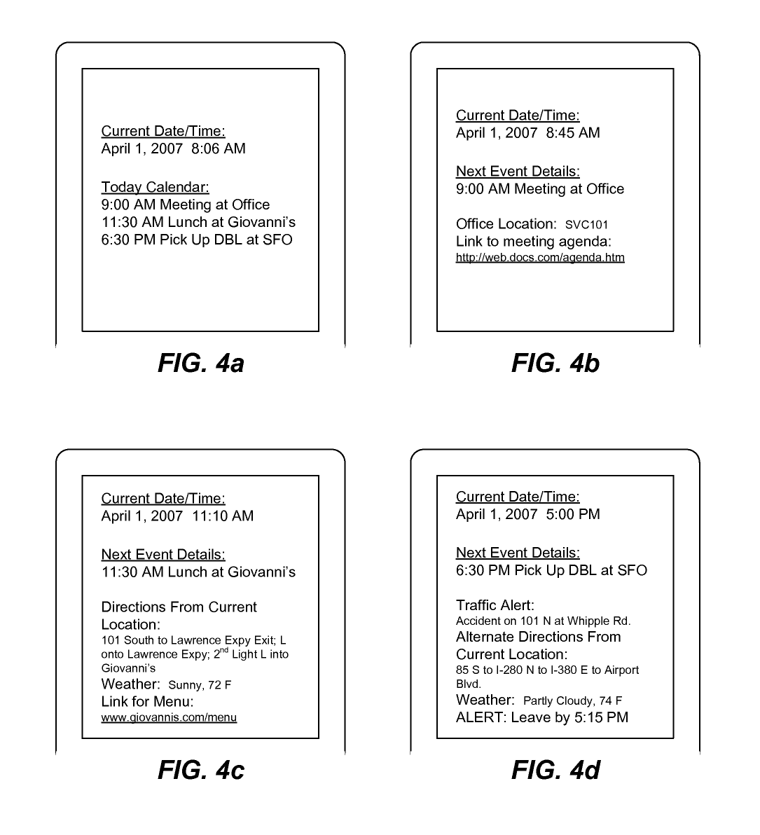

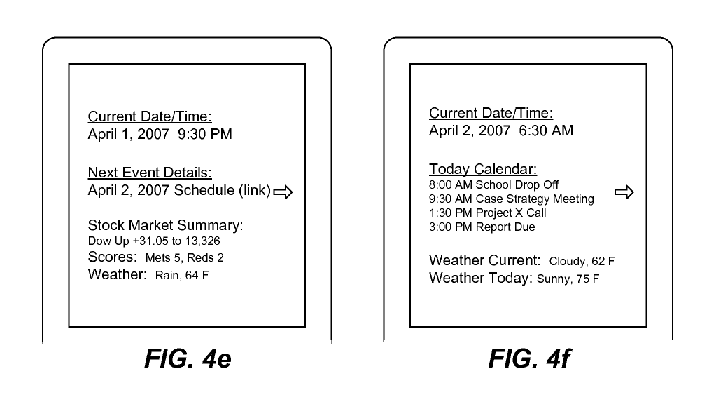

FIG. 3 illustrates one embodiment of a process to display specific information of interest within a specific time period. The process will be further described with reference to FIGS. 4a through 4f. FIGS. 4a through 4f illustrate example home (or base) screens for one embodiment of process to display specific information of interest within a specific time period. It is noted that in one embodiment, the home (or base) screens illustrated may be the home (or base) screens rendered for an operating system operating on a mobile computing device, for example, the device 110.

Starting with FIG. 3, the process starts 310 and identifies 315 one or more data entries within, for example, an application. An example of an application is a calendar application and that data may be used to populate a base screen that is displayed on a screen 130 of a mobile computing device 110. An example of a base screen is a desktop screen of a laptop or desk computer system running the Microsoft Windows operating system or a today screen of a handheld computing device running Microsoft Windows Mobile.

The base screen is a main workspace (or working environment) in a graphical user interface of an operating system. Users open and work with files and programs (or applications) on the desktop, and can store files and shortcuts there as well. The user can also customize the look of the desktop with images or wallpaper and icons. For ease of discussion from this point, the base screen will be discussed in the context of a “today screen” shown in the examples of FIGS. 4a through 4b. In that context, FIG. 4a illustrates one example of a base screen, e.g., today screen, displayed on the screen 130 of a mobile computing device 110. The today screen in the example of FIG. 4a shows “Current Date/Time” and three “events” on the calendar for the day (“Today Calendar”). It its noted that the base screen differs from an applications launcher. The base screen contains, for example, shortcuts to frequently used applications whereas the application launcher (or programs view) is used to directly launch applications or programs. The base screen (or today view) is the default view when the mobile computing device 110 first powers up and is operational.

Referring back to FIG. 3, the process continues with comparing 320 the data entries with a preconfigured profile established by the user. The preconfigured profile may be set up by the user in advance and stored in, for example, the flash memory 214. The preconfigured profile may include information that is the type of information a user may find relevant in relation to the application on the base screen, e.g., the today screen. For example, such information may be information that corresponds to particular activities such as the events of the day, a location, an activity type (e.g., a meeting), or a combination thereof and/or a particular day and time (e.g., workday such as a weekday or off day such as a weekend). The type of information also would be of a type used to seek and compare and may specify where (e.g., web sites on the web or an intranet (private network; the private network may be accessible through a virtual private network (VPN) and/or authentication process using, for example, a login and password) to obtain such data, dates and time to show such data, format to show such data (e.g., order, location on screen, highlights) etc.

In one embodiment, the preconfigured profile may be user settable where a user can tag the type of information for the system. By way of example, the user may tag the type of information by flagging (or setting or checking) a prelisted selectable value (e.g., a category(-ies) or keyword(s)) or by entering free text in a field that can be further processed by the system (e.g., through a natural language processing subsystem that can scan or retrieve the entry and further analyze it).

Along with the comparison, the process accesses 325 additional information sources. The additional information sources may be internally within the device 110, e.g., a calendar application or a database, or external to the device but accessible by the device via a communication connections (e.g., WiFi or GPRS), e.g., World Wide Web (or www, or W3, or web) or intranet (private network) services. With the information gathered, the process 330 presents (or renders) the information on the base screen, e.g., the today screen, in a format as designated by the user. The process then determines whether to continue 335 and if so, loops back to once again execute the identifying, the comparing, the accessing, and the presenting steps. If the device 110 is shut down or the process is otherwise halted, it may end 440.

To further illustrate the process, reference is made to FIGS. 4a through 4f. Starting with FIG. 4a, the data entries include three calendar items corresponding to events at “9:00 AM”, “11:30 AM” and “6:30 PM”. The base screen may be viewable on the screen 130 of the device 110 when the screen is transitioned from an OFF (or off or sleep) state to an ON (or on or active) state. After the information is displayed on the screen 130 for some predetermined period of time, it may not be further viewable because the screen 130 may transition back to an OFF state. The base screen (and its information at this stage), however, may still remain when the screen 130 is transitioned into the ON state, until it is updated as further described herein. This transition may occur as a result of system action (e.g., an application transitions the state of the screen) or as a result of user activity (e.g. the user toggles a key or switch to transition the screen 130 state). A preconfigured setting by the user may include updating the base screen, i.e., the today screen in this example, with details corresponding to the next event.

Next, in FIG. 4b illustrates the screen 130 when a new base screen is displayed at “8:45 AM” in this example. If the screen 130 of the device 110 was in an OFF state, when it is transitioned to the ON state, the updated base screen now shows the “Next Event Details”, which includes a description of the event (“9:00 AM Meeting at Office”) as well as where the meeting is and a link to the agenda of for the meeting. For the system to determine what information to display on the base screen, the preconfigured settings may include a rule such that for any meetings, the system should display the meeting location and agenda location on the base page. The process (and system) could further be configured so that the meeting location details could be extracted from an internal source on the device 110, e.g., event details within the calendar application. Further, the agenda information could be extracted from a location external to the device 110, but accessible by the device 110, e.g., obtained from a company intranet by communicatively coupling a secured virtual private network (VPN) connection through the device.

Continuing on, the next event illustrated is in FIG. 4c and corresponds to “11:30 AM Lunch at Giovanni's”. Here again, if the screen 130 of the device was in an OFF state, the user would see the screen of FIG. 4c when the device is in an ON state at this time. In this example, the user preconfigured setting is set so that commute time from a present location to the meeting location is accounted for in terms of when the event details appear on the base screen, e.g., the today screen. For example, the analysis engine 270 is configured to determine what the when and where the next event is (here, “11:30 AM Lunch at Giovanni's”). The time is given in this example—“11:30 AM”.

The location for the meeting may be extracted (or determined) through a number of different ways, including, address details from within the calendar entry itself, a lookup within a contacts database, or a lookup through a web service (such as a yellow pages or local area business search through a search engine). Based on the preconfigured setting, the analysis engine 270 uses the GPS subsystem 272 in the device 110 to detect the current (or present) location the user is at based on the location of the device 110. Thereafter, taking into account the present time, the time of the next meeting, the current location, and the location of the next meeting, the analysis engine 270 determines the time to render the new base screen, e.g., the today screen, accordingly.

In addition, the analysis engine 270 may extract out other details that may be relevant to display on the base screen. In this example, Giovanni's is a restaurant so the analysis engine 270 may be configured to use the location information to determine directions to it from the current location. Further, it also may extract a menu link in case the user seeks to peruse the menu in advance. Finally, the analysis engine 270, based on the preconfigured settings within the device 110, may extract weather information from a web service (or web site), which the user may find relevant prior to moving from the current location.

In one embodiment, the user may be reminded audibly (e.g., a notification sound from the device 110) or physically (e.g., a vibration of the device 110) so that when the user activates the device and the base screen appears, the user sees the next event details as well as other relevant information such as “Directions From Current Location”, “Weather”, and a “Link for Menu: www.giovannis.com/menu” at the restaurant.

FIG. 4d continues the example begun in FIG. 4a. Here, the base screen (again, viewed by a user when the screen 130 of the device 110 is in an ON state) illustrated now references the third event (“6:30 PM Pick up DBL at SFO”) noted in FIG. 4a, which was the beginning of the day. As with the example illustrated in FIG. 4c, in this example, the preconfigured settings by the user are structured so that the analysis engine 270 determines the next event, the time for that event (“6:30 PM”), the location of that event (“SFO” (San Francisco International Airport)), and the current location (in this example, an office location off of a highway 85 that is between a highway 101 and an interstate 280).

Starting with the data extracted from the event in the calendar application on the device 110, the analysis engine 270 queries the GPS subsystem 272 to determine the current location of the device. The analysis engine 270 then retrieves additional data from web services (e.g., through a WiFi or GPRS connection from the device 110) relating to traffic conditions and weather. The web services note a “Traffic Alert” of “Accident on 101 N at Whipple Rd”. If so preconfigured, the traffic alert may trigger the analysis engine 270 to query for alternate directions from web services as well as an additional “ALERT” to note what time to leave by (in this example, “5:15 PM”). In this example, the alternate route is provided. In addition, the preconfigured settings by the user instruct the analysis engine to retrieve weather information from web services for these types of events (e.g., those events involving driving from point A to point B). Once all the data is gathered by the analysis engine 270, it is displayed as the base screen on the screen 130 of the device 110. The user may be audibly (e.g., an audible tone) or physically (e.g., a vibration) alerted when the base screen is updated as such.

As the day continues in the example provided, there may be no more events in the present day. FIG. 4e illustrates an example base screen that is rendered in such a situation. In this example, the “Next Event Details” provide a “link” to the “Apr. 2, 2007 Schedule→”. In addition, the user may configured the system to have the analysis engine 270 extract out a summary of the day's events, for example, news headlines, stock market details, and sports scores. In addition, the user may configure the system to extract out other details from sources such as web services, for example, present weather or the next day weather. Once the analysis engine 270 collects and aggregates the information it renders the base page on the screen 130 of the device 110 as illustrated in FIG. 4e.

FIG. 4f illustrates an example of a base screen that would appear on the screen 130 of device 110 at the beginning of the next day “Apr. 2, 2007” when the user puts the device 110 into the ON state. In this example, based on the predetermined configuration set by the user, the base screen provides information on “Current Date/Time” and “Today Calendar” as shown in FIG. 4a, and also provides “Current” and “Today” weather forecast details that may be beneficial for the user as the user prepares for the current day.

The disclosed system and method embodiments dynamically evaluate, analyze retrieves and render information relevant to present time on a base screen of a device 110 when the user puts the screen 130 of the device 110 in an ON state. Having the most pertinent information immediately available when the screen 130 of the device 110 goes into an ON state simplifies tasks for user and removes the need to have to “think about” where to retrieve such additional information. Hence, the user need not expend extra management cycles and physical efforts to retrieve additional information corresponding to a present matter, event, activity, etc., from a multitude and/or variety of additional sources.

Other advantages include allowing a user to discover activities of interest in a given area even when no calendar events are scheduled. For example, a user may save time and receive reminders when it is time to leave based on traffic conditions rather than any specific event. When the device is configured to leverage web based information in decision making in various situations evaluate what the user is interested in (e.g., through review and evaluation of the preferences profile) along with knowing where the user is (e.g., through the GPS 272), and what the user is currently engaged in (e.g., based on time of day and where the user may be expected (such as the office or in a meeting that was on the calendar at the particular time of the alert)) the device 110 becomes a truly intelligent device.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Again, it is noted that upon reading this disclosure, those of skill in the art will appreciate still additional alternative structural and functional designs for a system and a process for automatically displaying specific information of interest at a specific time through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for rendering information of interest on a computing device, the method comprising:
identifying a plurality of time periods within in a database;
accessing a user profile, the user profile including data on information of interest for a user;
comparing, for each time period, the user profile with that specific time period to determine the information of interest for the user within the specific time period;
retrieving, in response to the comparison, information from at least one data source corresponding to the determined information of interest for the user within the specific time period; and
rendering at a time relative to each time period a base screen on a display of the computing device, the base screen including the determined information of interest for the user within the specific time period.

2. The method of claim 1, wherein the computing device comprises a mobile telephone configured to provide web access.

3. The method of claim 2, wherein the base screen comprises a today view.

4. The method of claim 2, wherein the database comprises a calendar program.

5. The method of claim 3, wherein the data source comprises a web service.

6. The method of claim 5, further comprising:
retrieving location information from a global positioning subsystem in the handheld computing device;
transmitting the location information to the web service for use by the web service; and
receiving from the web service data corresponding to the transmitted location information.

7. A tangible computer readable medium storing instructions thereon, the instructions when executed by a processor causes the processor to:
identify a plurality of time periods within a database;
access a user profile, the user profile including data on information of interest for a user;
compare, for each time period, the user profile with that specific time period to determine the information of interest for the user within the specific time period;
retrieve, in response to the comparison, information from at least one data source corresponding to the determined information of interest for the user within the specific time period; and
render at a time relative to each time period a base screen on a display of the computing device, the base screen including the determined information of interest for the user within the specific time period.

8. The computer readable medium of claim 5, wherein the computing device is a mobile phone configured to provide web access.

9. The computer readable medium of claim 5, wherein the base screen comprises a today view.

10. The computer readable medium of claim 8, wherein the database comprises a calendar program.

11. The computer readable medium of claim 10, wherein the data source comprises a web service.

12. The computer readable medium of claim 11, further comprising instructions that cause the processor to:
retrieve location information from a global positioning subsystem in the handheld computing device;
transmit the location information to the web service for use by the web service; and
receive from the web service data corresponding to the transmitted location information.

13. A method operational within a mobile phone without user intervention, the mobile phone configured to provide web access, the method to display on a base screen of the mobile phone information specific to a time period, the method comprising:
retrieving an entry from a calendar application within the smartphone, the entry including time data and location data for an activity;
accessing a user profile at a predetermined time relative to the time data in the entry, the user profile comprising tags corresponding to a type of information of interest to the user, the information of interest corresponding to at least one of;
comparing the information of interest from the user profile with the time data and the location data to determine the tags corresponding to the type of information of interest relative to the time data and the location data of the entry;
transmitting the tags to a web service;
retrieving from the web service data relating to the information of interest to the user corresponding with the time data and location data; and
displaying on the base screen of the mobile phone at a predetermined time relative to the time data, retrieved data from the web services.

14. The method of claim 13, wherein the web services comprises an Internet-based application for generating driving directions.

15. The method of claim 13, further comprising accessing an intranet through a virtual private network.

16. The method of claim 15, wherein the web services comprises a network application accessible on the intranet.

17. The method of claim 13, wherein the tags comprise keywords.
